(19) United States
(12) Patent Application Publication
(10) Pub. No.: US 2009/0037039 A1
(43) Pub. Date: Feb. 5, 2009

(54) Method for locomotive navigation and track identification using video

(75) Inventors: Ting Yu, Schenectady, NY (US); Frederick Wilson Wheeler, Niskayuna, NY (US); Robert August Kaucic, Niskayuna, NY (US); Paulo Ricardo Mendonca, Clifton Park, NY (US); Ajith Kuttannair Kumar, Erie, PA (US); Glenn Robert Shaffer, Erie, PA (US); Thomas Baby Sebastian, Flemington, NJ (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/904,761

(22) Filed: Sep. 27, 2007

Related U.S. Application Data
(60) Provisional application No. 60/963,069, filed on Aug. 1, 2007.

(51) Int. Cl. G06F 17/00

(52) U.S. Cl. 701/19

(57) ABSTRACT

A system for determining a track location operates to acquire a current video frame via at least one video camera mounted on board a locomotive, determine a track location based on information extracted from the at least one video frame, and transmit the track location information to a navigation system to determine control parameters for the locomotive.

### CLAIM TO PRIORITY OF PROVISIONAL APPLICATION

This application claims priority under 35 U.S.C. §119(e)(1) of provisional application Ser. No. 60/963,069, filed Aug. 1, 2007, by Ting Yu et al.

### BACKGROUND

The invention relates generally to locomotive navigation, and, in particular, to a system and method for determining which track a locomotive is on when the locomotive is on one of several tracks.

Locomotive video systems are known for their use in rail traffic control. One known locomotive video system employs a signal locating system and a rail navigation system to determine the position that the locomotive vehicle occupies on the railway track, and provides the signal locating system with data as to the whereabouts of the upcoming wayside signal device relative to the position of the vehicle, for example, to guide locomotive vehicles safely and quickly along signaled routes.

Locomotive audio/video recording systems are also known in the art. An exemplary locomotive audio/video recording system is the RailView™ system available from Transportation Technology Group. In such audio/video recording systems, video data and optionally audio data are stored to a high capacity memory device such as a floppy disk drive, hard disk drive or magnetic tape.

Known automatic locomotive navigation systems need to accurately determine a position of a locomotive vehicle for purposes of routing and speed control. Such known locomotive navigation systems, while capable of reliably determining where along a route a locomotive is located when using GPS devices, are still not accurate enough to indicate which track the locomotive is using when there are multiple tracks close to one another.

Accordingly, there exists a need for a reliable system and method for providing locomotive navigation and track identification. It would be both advantageous and beneficial if the system and method could employ video camera equipment and devices already present on the locomotive to detect individual track rails and tracks with or without using a database of prior images of the appearance of the tracks. It would be further advantageous if the system and method were less vulnerable to intermittent failure than known systems and methods that employ, for example, accelerometers that are used to measure rotation of a locomotive as it progresses through switches.

### BRIEF DESCRIPTION

Briefly, in accordance with one embodiment of the present invention, a method is provided for locomotive navigation and track identification. The method, in one embodiment, comprises:

acquiring at least one current video frame via at least one video camera mounted on a locomotive;

processing the at least one current video frame to identify each rail or pairs of rails occupied by the locomotive; and

transmitting information about the identified rail or pairs of rails to a navigation system to determine desired control parameters for the locomotive.

According to another embodiment, a method for locomotive navigation and control comprises:

determining a locomotive track location based on acquired video frame information; and

transmitting the track location to a navigation system to determine desired control parameters for the locomotive based on the track location.

According to yet another embodiment, a video processing system for locomotive navigation and identification comprises:

at least one video camera mounted on a locomotive and configured to acquire at least one video frame; and

a data processing system on-board the locomotive and configured to determine at least one track location based on information extracted from the at least one acquired video frame.

### DRAWINGS

These and other features, aspects, and advantages of the present invention will become better understood when the following detailed description is read with reference to the accompanying drawings in which like characters represent like parts throughout the drawings, wherein:

FIG. 1 is a flow chart illustrating a method of locomotive navigation and track identification, in accordance with one embodiment of the present invention;

FIG. 2 is a pictorial diagram illustrating a locomotive navigation and track identification system, according to one embodiment;

FIG. 3 depicts a vanishing point for a set of rail tracks;

FIG. 4 illustrates a vanishing point search region for a set of rail tracks;

FIG. 5 illustrates a pixel vanishing point direction and a pixel dominant orientation for one set of rail tracks;

FIG. 6 illustrates a pixel vanishing point direction and a pixel dominant orientation for another set of rail tracks.

FIG. 7 illustrates a pixel vanishing point direction and a pixel dominant orientation for yet another set of rail tracks;

FIG. 8 illustrates a pixel histogram of gradient orientation for the set of rail tracks depicted in FIG. 5;

FIG. 9 illustrates a pixel histogram of gradient orientation for the set of rail tracks depicted in FIG. 6;

FIG. 10 illustrates a pixel histogram of gradient orientation for yet another set of rail tracks depicted in FIG. 7;

FIG. 11 illustrates searching an angular range to identify rails of an occupied track based on rail scores for lines to the vanishing point;

FIG. 12 illustrates joint detection to identify a set of tracks, according to one embodiment;

FIG. 13 is a flow chart illustrating a more generic method of track detection and identification according to one embodiment;

FIG. 14 depicts a locomotive segmented from an acquired video image according to one embodiment;

FIG. 15 illustrates an image depicting a pair of rail tracks acquired under daylight conditions;

FIG. 16 illustrates an image depicting a pair of rail tracks acquired under nightlight conditions;

FIG. 17 is a flow chart depicting a method of segmenting a locomotive from an acquired image according to one embodiment;

FIG. 18 is an acquired image that has been partitioned to show the bottom one-third of the image profile;

FIG. 19 is a flow chart depicting a method of pre-processing an acquired image to enhance track recognition according to one embodiment;

FIG. 20 is an acquired image that has been partitioned to show the middle one-third of the acquired image;

FIG. 21 illustrates the appearance of an original image following the background image subtraction, contrast enhancement, and edge detection pre-processing steps shown in FIG. 19;

FIG. 22 depicts an exemplary scene constraint including a point at infinity (vanishing point) where two pairs of rails meet and a one-dimensional (1D) homography for a length of straight tracks;

FIG. 23 depicts an exemplary scene constraint including a point at infinity (vanishing point) where two pairs of rails meet and a one-dimensional (1D) homography for a length of curved tracks;

FIG. 24 illustrates one acquired image depicting two line-pairs that are processed to determine a vanishing point 200;

FIG. 25 illustrates a top view and a video camera perspective view model of the two line-pairs shown in FIG. 24;

FIG. 26 illustrates an original image;

FIG. 27 illustrates an acquired image based on the original image shown in FIG. 26;

FIG. 28 illustrate another original image; and

FIG. 29 illustrates an acquired image based on the original image shown in FIG. 28.

While the above-identified drawing figures set forth alternative embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION

The present inventors recognized that knowledge of substantially parallel lines in the world coupled with the location of the principal point can be used to limit the search for railroad tracks within captured images. An introductory discussion is first presented below to provide a better understanding of the embodiments described below with reference to the figures.

A single-dimensional (1D) homography, for example, can be computed between three or more railroad tracks and the actual railroad tracks in the world. This ID mapping provides a direct correspondence between real world and image lines. Thus, putative railroad track locations can be projected into images of the tracks. Image support can then be used to verify the presence/absence of various track configurations.

The location of the foregoing principal point can be determined using various methods. One exemplary method is the intersection of two or more parallel world lines, e.g. the imaged railroad tracks. Another exemplary method is to use the focus of expansion of a moving camera. In a railroad setting, a camera mounted inside of the locomotive can provide the necessary time-series data. Optic flow, point tracking, or other suitable methods can then be used to determine the location of the principal point.

The image to world mapping (the 1D homography) can be computed by manually delineating 3 or more parallel world lines and intersecting the lines with a fourth, non-parallel line. Alternatively, automatic rail detection methods can be used to find the desired lines and then virtually intersect the rails with a fourth line.

Various methods can be used to determine whether or not sufficient image support exists to confirm the presence of a rail or track. Gradient-based and ridge-based methods are two such suitable methods.

The use of geometrical constraints imposed by a world to image mapping has been presented above for use in a railroad setting to provide a background suitable to a better understanding of the embodiments described below with reference to the figures. It can be appreciated that such methods are equally suitable for other “line detection” type problems, such as finding lane or road markings on roads.

The following description presents a system and method for locomotive navigation and track identification using video information, according to particular embodiments. The system and method use a video camera mounted on a locomotive or train to generate video frames as an input to a track identifier, to determine which track a locomotive is on when the locomotive is on one of several nearby tracks. A master navigation system calls upon the track identifier as needed, or the track identifier may be used at regular intervals.

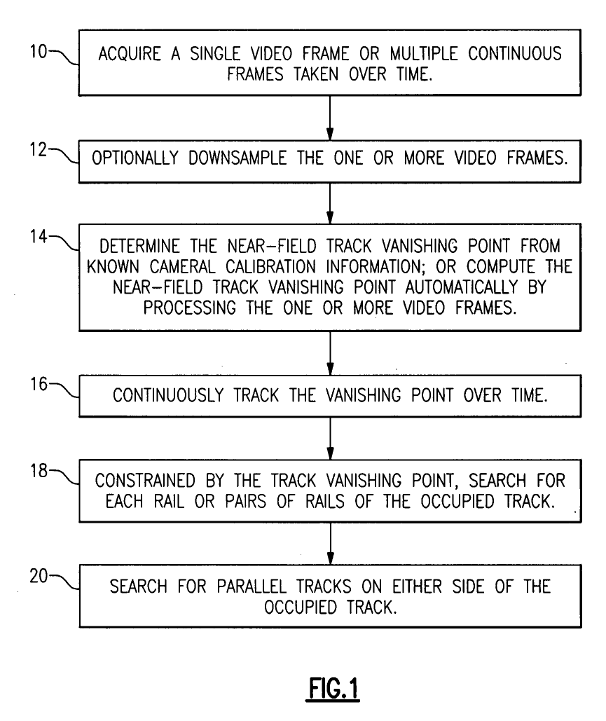

Turning now to the drawings, FIG. 1 is a flow chart illustrating a method of locomotive navigation and track identification, in accordance with one embodiment of the present invention. The method commences by first acquiring a single video frame or multiple continuous video frames over a desired period of time via one or more video cameras mounted on board the locomotive, as represented in block 10.

Subsequent to acquiring a single video frame or multiple continuous video frames over a desired period of time, frames optionally can be downsampled using conventional image processing techniques, as represented in block 12.

The near-field track vanishing point can be determined from known camera calibration information associated with the single video frame; or the near-field track vanishing point can be computed automatically by processing the video frame(s) data via a CPU, microprocessor, DSP, or other suitable data processing means. This step is represented in block 14 of FIG. 1.

The near-field track vanishing point, as used herein, means that point where tracks appear to converge into a single point in the image space when looking in the direction of locomotive travel down the path of the tracks.

The camera calibration information, in one embodiment, is associated with one or more video cameras permanently on-board the locomotive. Using the on-board video camera(s) (lococam), allows the use of already known video camera operating and calibration parameters such as mounting angle and viewing angles, among others, since the video camera is in a permanent fixed position on-board the locomotive. An acquired video image can then be processed using a reverse computational process based on the lococam operating and calibration parameters to identify the three-dimensional position of an object within the image and to determine the near-field track vanishing point.

Downsampling the acquired video image information, such as represented in block 12, is useful when faster processing is desired to gain faster results. Such downsampling allows the use of more powerful processors that are not part of the lococam system, to process the acquired video image information in real time. Faster processing is generally more desirable when processing multiple images because the number of computations required by the computational process increases in a linear relationship with the number of image pixels in the acquired video images.

The vanishing point of the tracks is tracked continuously over a desired period of time as represented in block 16.

Constrained by the track vanishing point, a search is performed to determine each rail or pairs of rails that are occupied by the locomotive, as represented in block 18. Each rail, in one embodiment, is identified using the near-field track vanishing point in a two-dimensional image space. The near-field track vanishing point is that point where all tracks converge in the two-dimensional image space. Angular data associated with each track or pairs of tracks are then used in association with the near-field track vanishing point to identify each track or pairs of tracks.

The foregoing process is then employed to also identify tracks on either side of the occupied track, as represented in block 20. The track identifier can also use information about the layout of the track, which may serve as a geometric constraint to search for tracks, if such information is available. The on-board locomotive system knows its approximate location from GPS measurements or other input data. Based on this knowledge and a track database, the on-board locomotive system may know the number of tracks, the gauge of the tracks, the distances between the tracks and the relative heights of the tracks, among other things. Further, the system may know whether the neighboring tracks are actually visible, and other distinguishing features of those tracks such as ballast material that may aid in their detection.

FIG. 2 is a pictorial diagram illustrating a locomotive navigation and track identification system 100, according to one embodiment. System 100 includes an on-board track identification system 120 that communicates with a master navigation system 110 via a wireless communication system 130.

On-board track identification system 120 includes a track identifier unit 104 that may include without limitation, a computer or processor, logic, memory, storage, registers, timing, interrupts, and the input/output signal interfaces as required to perform the track identifier processing described herein before. The track identifier unit 104, according to one embodiment, receives inputs from a data storage unit 106 that may store a database of track parameters such as described above, at least one on-board video camera (lococam) 102, and a master navigation system 110 via a wireless communication system 130. It will be appreciated that while in an exemplary embodiment, all or most processing is described as resident in the track identifier unit 104, such a configuration is illustrative only. Various processing and functionality may be distributed among one or more system elements without deviating from the scope and breadth of the claims.

The data storage unit 106 is configured with sufficient capacity to capture and record data to facilitate performance of the track identification functions disclosed herein. In one embodiment, data storage unit 106 uses flash memory. Data storage unit 106 may also include non-volatile random access memory (RAM). The data storage unit 106 is comprised in one embodiment, of a solid-state, non-volatile memory of sufficient storage capacity to provide long-term data storage of captured video image data and information, such as but not limited to, video camera calibration information. Once again, it will be appreciated that while the data storage unit 106 is described as a separate entity from the track identification unit 104, either or both could be configured to be separate or combined, as well as being combined with other elements of the on-board system 120. Further, it should be appreciated that while particular partitioning of the processing and functionality is disclosed herein, such partitioning is illustrative only to facilitate disclosure. Many other arrangements and partitions of like functionality will be readily apparent.

The video camera 102, in one embodiment, features aiming and zooming mechanisms that can be externally controlled to aim the camera at an upcoming object with high clarity, even at relatively long distances. Video camera 102 can optionally control lighting effects, resolution, frequency of imaging, data storage, and information concerning video system parameters. Video camera 102 may further take advantage of video technologies that facilitate low/no light image collection or collection of specific images. Examples include infrared and detection of specific images.

One or more video cameras 102 can be employed to acquire the desired track images. The video camera(s) 102 may be directed out the front of the locomotive, to either side, or to the rear of the locomotive; or multiple cameras may be used to capture images from multiple areas.

On-board track identification system 120 also includes, in one embodiment, a communication system 108 that may facilitate a particular type of communication scheme or environment including, but not limited to wireless satellite communications, cellular communications, radio, private networks, a Wireless Local Area Network (WLAN), and the like, as well as combinations including at least one of the foregoing.

A GPS receiver on-board the locomotive in one embodiment, is accurate enough to identify a curve on which the locomotive is located. GPS information may further be coupled with other navigational aids to further facilitate accurate position location and determination. The GPS information may further be coupled with stored information about the track to further facilitate a determination of where the locomotive (and thereby the train) is on the track relative to fixed waypoints or entities.

If any neighboring tracks are occupied, the on-board track identification system 120 may not be able to determine which track the locomotive is on, depending on the arrangement of tracks. When this condition occurs, the track identification system in one embodiment, will report which tracks are occupied, and whether it is able to identify the current track occupied by the locomotive.

Further, unforeseen circumstances may exist that cause the track identifier to fail. When this happens, the track identifier in one embodiment, reports that it cannot determine the current track occupied by the locomotive. The track identifier can be configured to attempt track identification at a later time; or it can be requested to check again later by the master navigation system 110. A fail-safe system such as manual intervention, can also be employed to start the track identification process.

In summary explanation, an automatic locomotive navigation system needs to accurately determine its location for purposes of routing and speed control. While GPS navigation can reliably determine where along a route a locomotive is located, GPS is not accurate enough to tell which track the locomotive is using when there are multiple tracks close to each other. At least one video camera 102 mounted on a locomotive or train is used as an input to a track identifier unit 104 to determine which track a locomotive is on when the locomotive is on one of several tracks. A master navigation system 110 calls upon the track identifier as needed, or the track identifier may be used at regular intervals for routing and speed control purposes, among other things.

The track identifier can optionally be used as in input to a trip optimizer autopilot onboard the locomotive, allowing the autopilot controls to adjust locomotive speed based on speed limits and optimize fuel consumption. A feature of the foregoing locomotive navigation system includes its ability to function in diverse weather, environmental and lighting conditions due to its robust architecture.

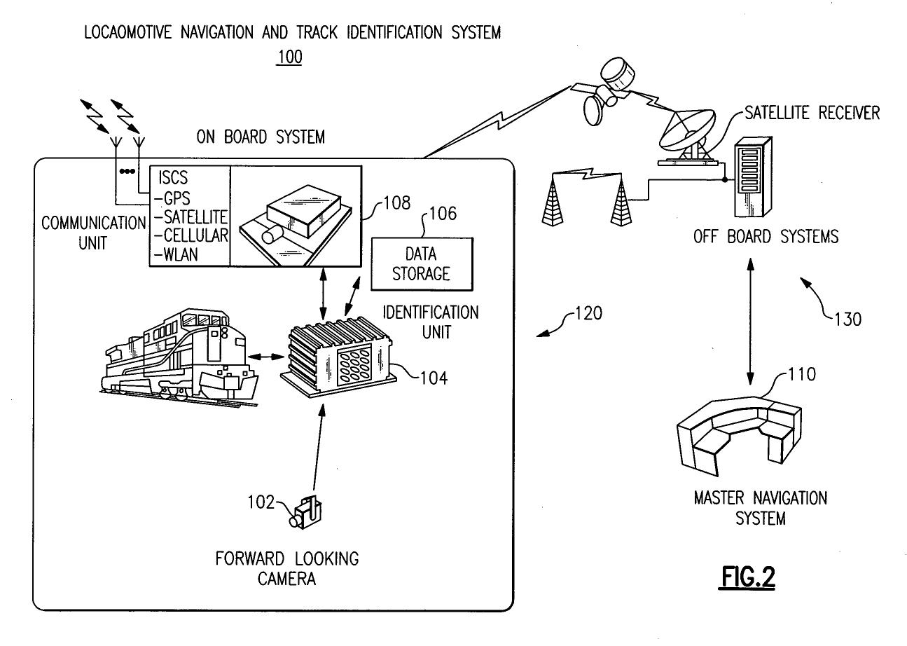

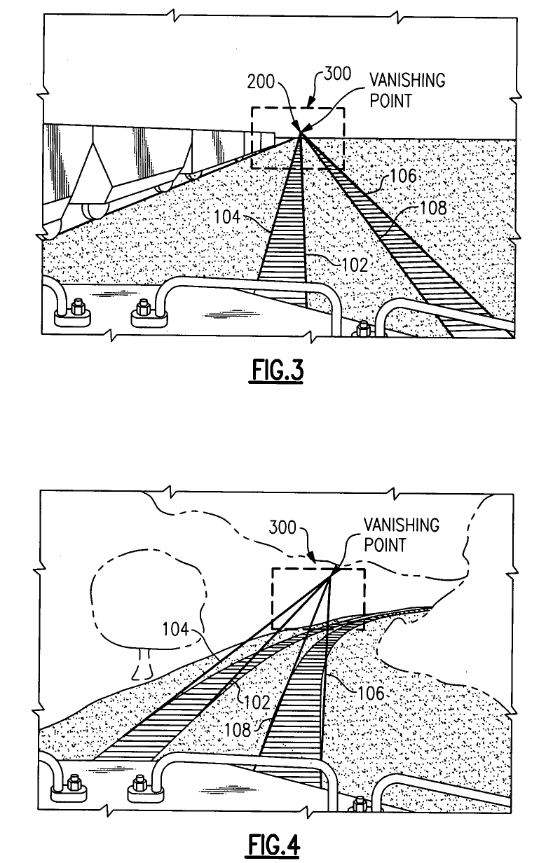

FIG. 3 depicts a vanishing point 200 for a set of rail tracks 102, 104, 106, 108. Constrained by the track vanishing point 200, a search is performed to determine each rail or pairs of rails that are occupied by the locomotive. Each rail 102, 104, 106, 108, in one embodiment, is identified using the near-field track vanishing point in a two-dimensional image space. The near-field track vanishing point, as stated herein before, is that point where all tracks converge in the two-dimensional image space. Angular data (slope) associated with each track or pairs of tracks is then used in association with the near-field track vanishing point (intercept) to identify each track or pairs of tracks.

FIGS. 3 and 4 illustrate a vanishing point search region 300 for a set of rail tracks 102, 104, 106, 108. Although the rail tracks are curving in FIG. 4, the near-field track vanishing point 200 can still be determined with the near-field image features generated via the captured video image and used to accurately identify each track or pairs of tracks using the angular data (slope).

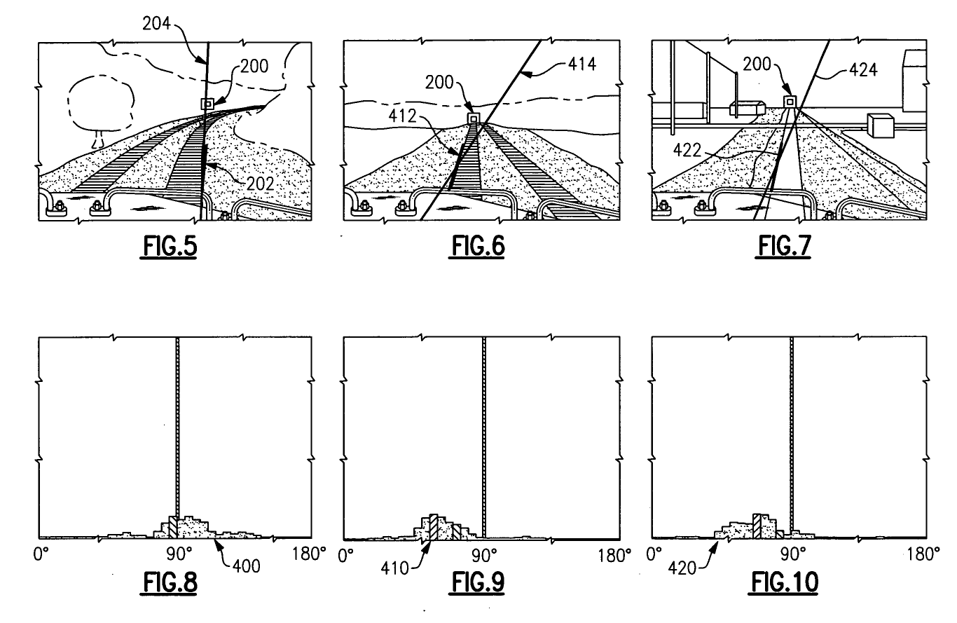

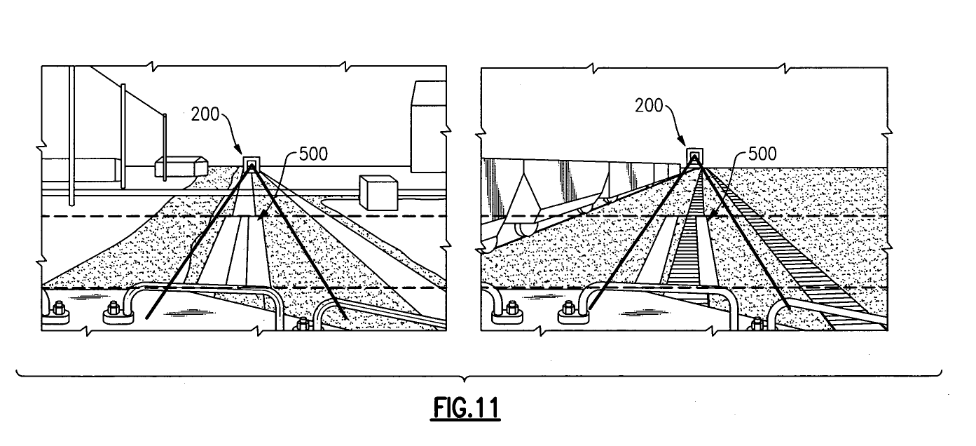

FIGS. 5-10 illustrate a set of pixel histograms of gradient orientations 400, 410, 420 associated with corresponding sets of rail tracks associated with a set of acquired video images. FIG. 8, for example, is a histogram illustrating the relationship between the vanishing point 200 and a corresponding pixel vanishing point direction 202 and a corresponding pixel dominant orientation 204 for the set of rail tracks depicted in FIG. 5. Each pixel can be seen to have a dominant orientation that is the peak of its corresponding neighborhood edge orientation histogram. Further, each pixel can be seen to have a vanishing point direction 202 that also has strong support in the corresponding neighborhood edge orientation histogram. Dominance is depicted in the histogram by the height of each bar. Strength of support for the pixel vanishing point direction in each histogram is depicted by the height of the histogram bar corresponding to the vanishing point direction. Similarly, FIG. 9 is a histogram illustrating the relationship between the vanishing point 200 and a corresponding pixel vanishing point direction 412 and a corresponding pixel dominant orientation 414 for the set of rail tracks depicted in FIG. 6. FIG. 10 is a histogram illustrating the relationship between the vanishing point 200 and a corresponding pixel vanishing point direction 422 and a corresponding pixel dominant orientation 424 for the set of rail tracks depicted in FIG. 7.

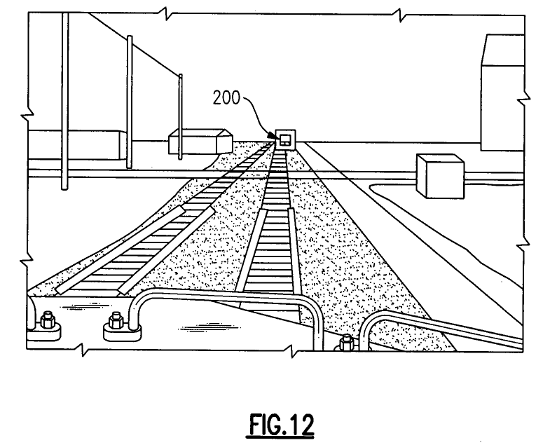

FIG. 11 illustrates searching an angular range to identify rails of an occupied track 500 based on rail scores for lines to the vanishing point 200. The figure on the left depicts a vanishing point 200 as determined during low lighting conditions; while the figure on the right depicts the vanishing point 200 as determined during normal daylight hours. These results show that the degree of lighting has an effect on the accuracy of the near-field track vanishing point, although the accuracy is acceptable even during low lighting conditions.

FIG. 12 illustrates joint detection to identify a set of tracks occupied by a locomotive and an adjacent set of tracks, according to one embodiment. Although the joint track detection process was completed under night time (low light) lighting conditions, the track identification process was successful in identifying each set of tracks using the geometric constraint of resultant near-field vanishing point 200.

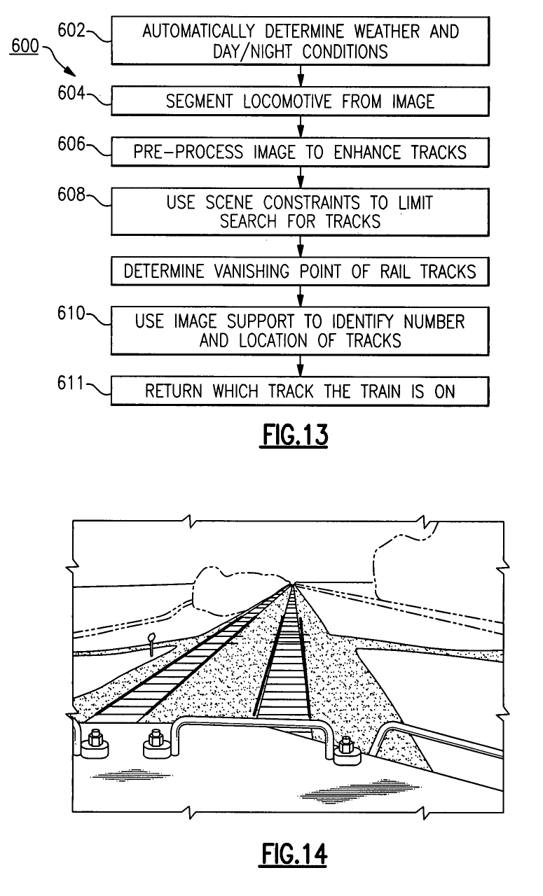

Moving now to FIG. 13, a flow chart 600 illustrates a more generic method of track detection and identification according to one embodiment. The method commences by automatically determining the present weather and lighting (day/night) conditions as represented in block 602.

Using the weather and light condition constraints from block 602, the locomotive is segmented from an acquired video image as represented in block 604, and such as depicted in FIG. 14.

Following the image segmentation described in block 604, the remaining segmented image is then pre-processed to enhance the tracks as represented in block 606.

Once the tracks have been enhanced in the acquired image, desired scene constraints such as but not limited to vanishing point constraints are then used to search for and identify the tracks as represented in block 608. It can be appreciated that although particular embodiments have been described with reference to vanishing point constraints, the invention is not so limited. Any number of other suitable techniques, processes, procedures, methods and algorithms can be employed to implement locomotive navigation and track identification using video in accordance with the principles described herein with or without the use of vanishing point constraints.

Image support is also employed to identify the number and location of the tracks as represented in block 610. The image support may include without limitation, location information from GPS measurements or other input data. Based on this knowledge and a track database, the on-board locomotive system may know the number of tracks, the gauge of the tracks, the distances between the tracks and the relative heights of the tracks, among other things. Further, the system may know whether the neighboring tracks are actually visible, and other distinguishing features of those tracks such as ballast material that may aid in their detection.

The track identification information is then returned to a desired location such as a trip optimizer autopilot or a master navigation system for further processing to determine desired system parameters including without limitation, speed limits as represented in block 611.

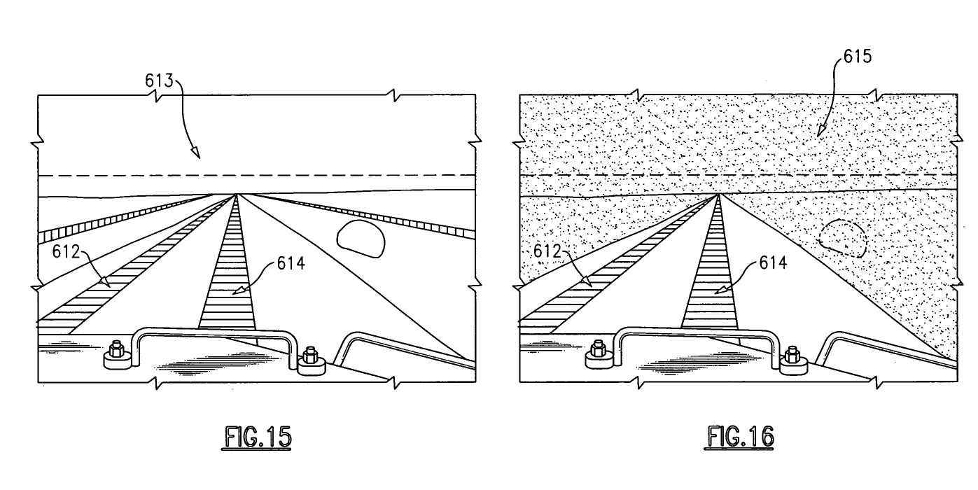

FIGS. 15 and 16 depict a pair of rail tracks 612, 614 during daylight and nightlight conditions respectively. Statistics of pixels in the top region 613 of FIG. 15 and in the top region 615 of FIG. 16, such as discussed herein before with respect to FIGS. 5-10, can be used to automatically determine weather and day/night conditions as represented in block 602 of FIG. 13.

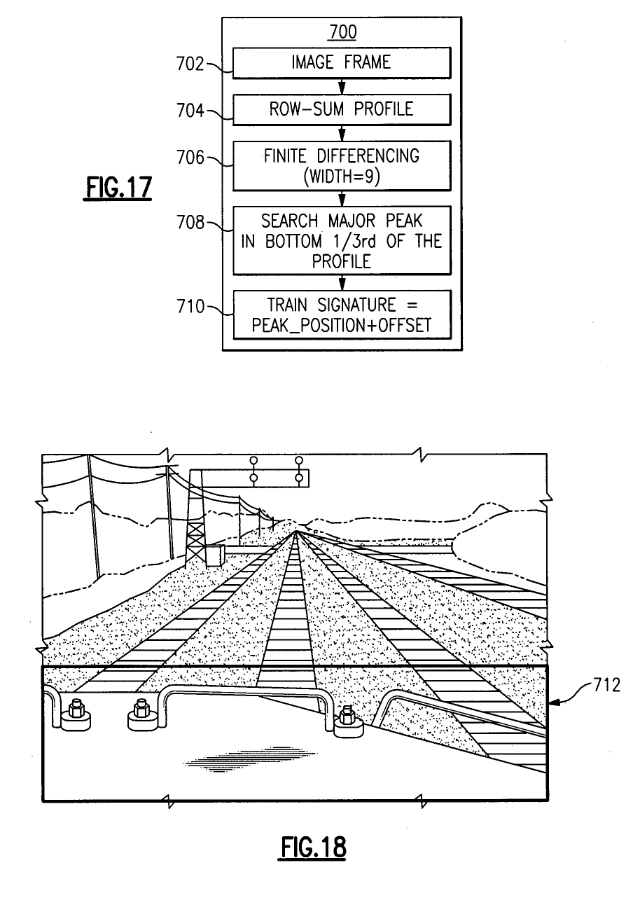

FIG. 17 is a flow chart 700 depicting a method of segmenting a locomotive from an acquired image such as represented in block 604 of FIG. 13, according to one embodiment. The process begins by first determining a row-sum profile from an acquired image frame as represented in blocks 702 and 704. Finite differencing is then employed to implement a search for a major peak in the bottom one-third of the profile 712 such as depicted in FIG. 18 as represented in blocks 706 and 708. Upon locating the major peak, a locomotive (train) signature is then determined by adding a predetermined offset to the peak position as represented in block 710.

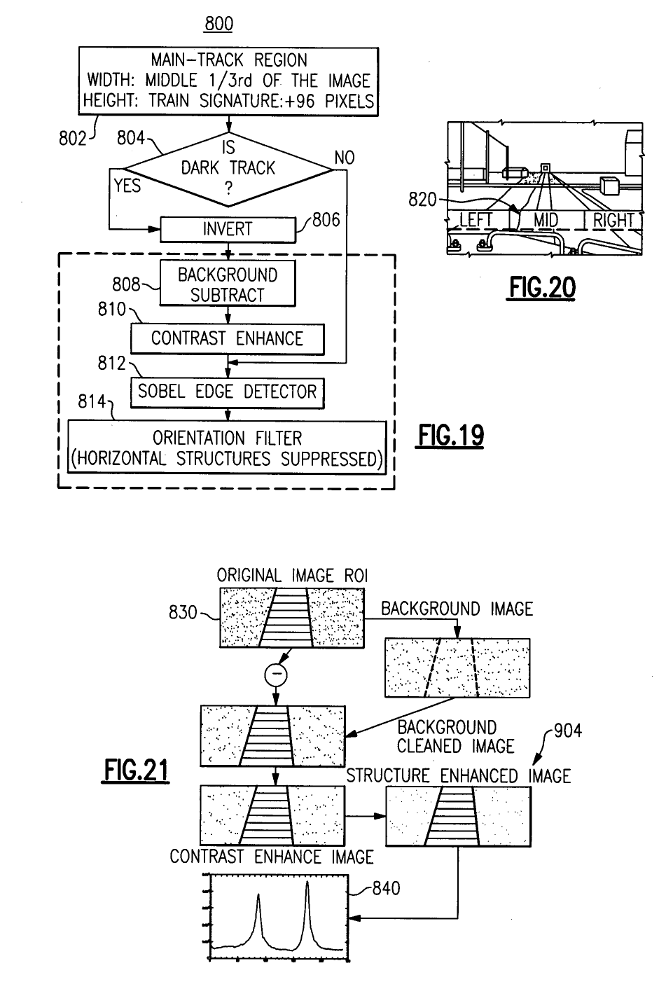

FIG. 19 is a flow chart 800 depicting a method of pre-processing an acquired image to enhance track recognition as represented in block 606 of FIG. 13, according to one embodiment. The method extracts information from the middle one-third 820 of the acquire image such as illustrated in FIG. 20, in which the height is determined by adding a predetermined number of pixels to the train signature as represented in block 802.

A determination is then made as to whether the acquired track image is dark as represented in decision block 804. If the acquired track image is dark, then the acquired image is inverted as represented in block 806, and the full pre-processing continues as represented in blocks 808-814 that represent background substraction, contrast enhancement, edge detection, and orientation filtering steps respectively. If the acquired track image is not dark, then the acquired image is subjected to less pre-processing via bypassing background subtraction 808 and contrast enhancing 810 steps.

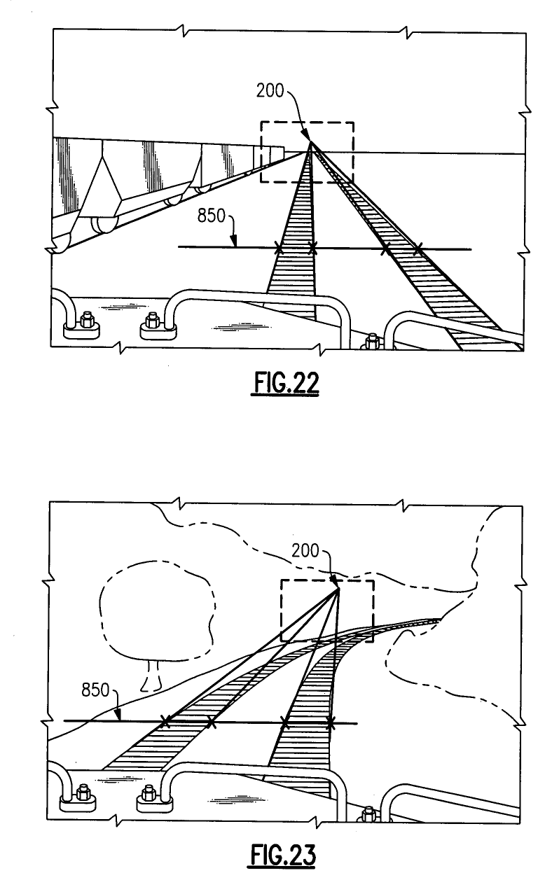

FIG. 21 illustrates the appearance of an original image 830 following the foregoing background image subtraction 808, contrast enhancement 810, and edge detection 812 pre-processing steps shown in FIG. 19. The resultant track signature 840 corresponds to the structure enhanced image 904.

Moving now to FIGS. 22 and 23, exemplary scene constraints including the point at infinity (vanishing point) 200 where two pairs of rails meet and a one-dimensional (1D) homography 850 are illustrated for a length of straight tracks and a length of curved tracks respectively. The vanishing point 200 and ID homography 850 are suitable for use as scene constraints to limit the search for tracks represented in step 608 of detection method 600 shown in FIG. 13.

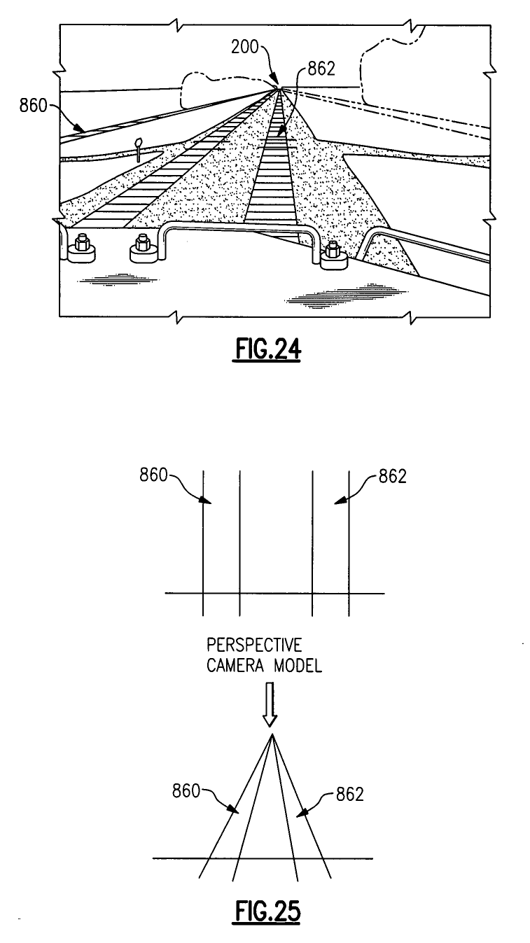

The foregoing method of track detection 600 can be employed as well to search over line-pairs instead of individual lines. FIG. 24 illustrates one acquired image depicting two line-pairs 860, 862 that are processed to determine a vanishing point 200. The foregoing track detection process 600 shows a locomotive is resident on line-pair 862.

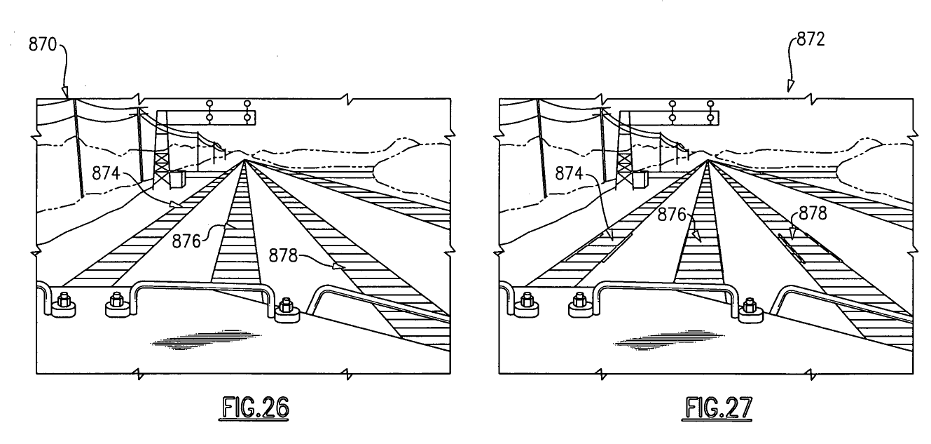

The top portion of FIG. 25 illustrates a top view of the two line-pairs 860, 862; while the bottom portion of FIG. 25 illustrates a video camera perspective view model of the two line-pairs 860, 862.

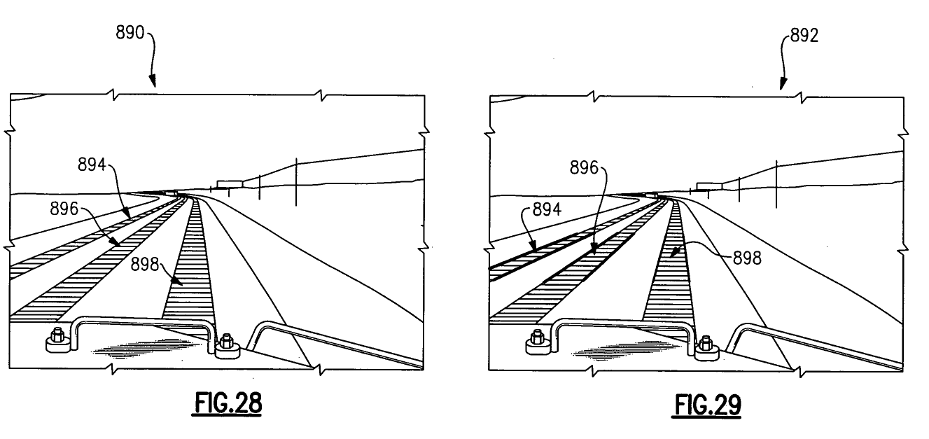

FIG. 26 illustrates an original image 870 while FIG. 27 illustrates one acquired image 872 based on the original image of FIG. 26. Three line-pairs 874, 876, 878 are processed using the foregoing track detection process 600 to show a locomotive is resident on middle line-pair 876.

FIGS. 28 and 29 similarly illustrate an acquired image 892 based on an original image 890. In this instance, three line-pairs 894, 896, 898 are processed using the track detection process 600 to show a locomotive is resident on right-most line-pair 898.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of locomotive navigation and track identification, the method comprising:
acquiring at least one current video frame via at least one video camera mounted on a locomotive;
processing the at least one current video frame to identify each rail or pairs of rails occupied by the locomotive; and
transmitting information about the identified rail or pairs of rails to a navigation system to determine desired control parameters for the locomotive.

2. The method of claim 1, wherein the desired control parameters are selected from speed and routing control parameters.

3. The method of claim 1, wherein processing the at least one current video frame to determine each rail or pairs of rails occupied by the locomotive comprises:
determining a near-field track vanishing point either based on current video frame calibration information or by computing it automatically; and
determining each rail or pairs of rails occupied by the locomotive based on near-field track vanishing point constraints.

4. The method of claim 3, wherein determining the near-field track vanishing point based on current video frame calibration information comprises determining the near-field track vanishing point based on pixel point directional data.

5. The method of claim 3, wherein determining the near-field track vanishing point based on current video frame calibration information comprises determining the near-field track vanishing point based on pixel point dominant orientation data.

6. The method of claim 3, wherein determining the near-field track vanishing point based on current video frame calibration information comprises determining the near-field track vanishing point based on video camera viewing angles.

7. The method of claim 3, further comprising determining the near-field track vanishing point based on a database of track information selected from at least one of the number of tracks, the gauge of the tracks, the distances between the tracks and the relative heights of the tracks.

8. The method of claim 3, wherein determining each rail or pairs of rails occupied by the locomotive based on near-field track vanishing point constraints comprises determining each rail or pairs of rails occupied by the locomotive based on two-dimensional intercept and slope data associated with an acquired track image.

9. The method of claim 1, wherein determining a locomotive track location based on acquired video frame information comprises determining each rail or pairs of rails occupied by the locomotive based on two-dimensional intercept data and slope data associated with an acquired track image.

10. A method of locomotive navigation and control, the method comprising:
determining a locomotive track location based on acquired video frame information; and
transmitting the track location to a navigation system to determine desired control parameters for the locomotive based on the track location.

11. The method of claim 10, wherein the desired control parameters are selected from speed and routing parameters.

12. The method of claim 10, wherein determining a locomotive track location based on acquired video frame information comprises determining a near-field track vanishing point based on current video frame calibration information.

13. The method of claim 12, wherein determining the near-field track vanishing point based on current video frame calibration information comprises determining the near-field track vanishing point based on pixel point directional data.

14. The method of claim 12, wherein determining the near-field track vanishing point based on current video frame calibration information comprises determining the near-field track vanishing point based on pixel point dominant orientation data.

15. The method of claim 12, wherein determining the near-field track vanishing point based on current video frame calibration information comprises determining the near-field track vanishing point based on video camera viewing angles.

16. The method of claim 12, wherein determining a locomotive track location based on acquired video frame information further comprises determining the near-field track vanishing point based on a database of track information selected from at least one of the number of tracks, the gauge of the tracks, the distances between the tracks and the relative heights of the tracks.

17. The method of claim 10, wherein determining a locomotive track location based on acquired video frame information comprises determining each rail or pairs of rails occupied by the locomotive based on two-dimensional intercept data and slope data associated with an acquired track image.

18. A locomotive navigation and identification system comprising:
at least one video camera mounted on a locomotive and configured to acquire at least one video frame; and
a data processing system on-board the locomotive and configured to determine at least one track location based on information extracted from the at least one acquired video frame.

19. The locomotive navigation and identification system of claim 18, wherein the data processing system comprises a database of track information selected from at least one of the number of tracks, the gauge of the tracks, the distances between the tracks and the relative heights of the tracks.

20. The locomotive navigation and identification system of claim 19, wherein the data processing system is further configured to determine a near-field track vanishing point based on the database of track information.

21. The locomotive navigation and identification system of claim 20, wherein the near-field track vanishing point constraints comprise slope data and intercept data associated with each track.

22. The locomotive navigation and identification system of claim 20, wherein the near-field track vanishing point constraints comprise pixel point directional data.

23. The locomotive navigation and identification system of claim 20, wherein the near-field track vanishing point constraints comprise pixel point dominant orientation data.

24. The locomotive navigation and identification system of claim 18, wherein the information extracted from the at least one acquired video frame comprises two-dimensional intercept data and slope data associated with an acquired track image.
